(19) United States
(12) Patent Application Publication
(10) Pub. No.: US 2025/0320141 A1
(43) Pub. Date: Oct. 16, 2025

(54) HYDROGEN PEROXIDE REMOVAL SYSTEM

(71) Applicant: PowerTech Water, Inc., Lexington, KY (US)

(72) Inventors: Alan Rassoolkhani, Lexington, KY (US); James Landon, Lexington, KY (US); Joseph Stieha, Lexington, KY (US); Collin Dunn, Lexington, KY (US)

(73) Assignee: PowerTech Water, Inc., Lexington, KY (US)

(21) Appl. No.: 19/175,463

(22) Filed: Apr. 10, 2025

Related U.S. Application Data
(60) Provisional application No. 63/633,300, filed on Apr. 12, 2024.
(60) Provisional application No. 63/695,959, filed on Sep. 18, 2024.
(60) Provisional application No. 63/705,262, filed on Oct. 9, 2024.

(30) Foreign Application Priority Data
Nov. 28, 2024 (KR) 10-2024-0173745
Nov. 29, 2024 (TW) 113146395

(51) Int. Cl. C02F 1/72; B01J 23/34; B01J 23/46; C02F 1/461; C02F 1/70; C02F 101/10; C02F 101/20

(52) U.S. Cl. CPC C02F 1/725; B01J 23/34; B01J 23/462; C02F 1/46109; C02F 1/705; C02F 2001/46138; C02F 2101/10; C02F 2101/20

(57) ABSTRACT

Systems and methods for purifying aqueous solutions include a hydrogen peroxide removal unit including a hydrogen peroxide decomposition media arranged to receive un-treated aqueous solution. The hydrogen peroxide decomposition media includes a platinum group catalyst that includes beads with a density of at least 1 gram/milliliter (g/ml).

### CROSS-REFERENCE TO RELATED APPLICATIONS

This application claims the benefit of Korean application number 10-2024-0173745, filed Nov. 28, 2024, Taiwanese application number 113146395, filed Nov. 29, 2024, U.S. Provisional application No. 63/705,262, filed Oct. 9, 2024, U.S. Provisional application No. 63/695,959, filed Sep. 18, 2024, and U.S. Provisional application No. 63/633,300, filed Apr. 12, 2024, all of which are incorporated by reference herein in their entireties.

### BACKGROUND

Embodiments described herein relate to hydrogen peroxide removal from liquid feed streams and for use as a pre-treatment step for water filtration devices.

Electrochemical cells, which can be in the form of cartridges with enclosed filter media, for removing heavy metals include one or more pairs of electrodes, an anode and a cathode, that remove or reduce the concentration of target species from an input stream and thereby provide an output stream with decreased content of the target species. In particular, when a sufficient external voltage (i.e., potential) is applied to the electrodes, non-spontaneous chemical reactions occur that reduce the concentration of target species (e.g., metal ions, halide ions, derivatives of target metals or target halides, or particulate metals) in the aqueous solution.

Depending on the process conditions, e.g., applied voltage, pH, type and concentration of target species, electrode spacing, and cell design, target species are selectively removed from the aqueous solution by various processes, including but not limited to physical adsorption to an electrode; electrical attraction (i.e., capacitive adsorption) to an electrode; and/or electron transfer reactions that directly or indirectly create new target species (i.e., Faradaic reactions) that become immobilized on an electrode.

### SUMMARY

According to one or more embodiments, a system for purifying an aqueous solution comprises a hydrogen peroxide removal unit comprising a hydrogen peroxide decomposition media arranged to receive un-treated aqueous solution, wherein the hydrogen peroxide decomposition media comprises a platinum group catalyst comprising beads with a density of at least 1 gram/milliliter (g/ml).

In some embodiments, the beads have a diameter of about 0.8 millimeters (mm).

In other embodiments, the un-treated aqueous solution comprises a mixture of sulfuric acid and hydrogen peroxide.

Yet in other embodiments, the system further comprises one or more of a heat exchanger, wherein a heat exchanger of the one or more of the heat exchangers is arranged upstream from the hydrogen peroxide removal unit, a heat exchanger of the one or more of the heat exchangers is arranged downstream from the hydrogen peroxide removal unit, or a combination thereof.

In some embodiments, a system for purifying an aqueous solution comprises a hydrogen peroxide removal unit comprising a hydrogen peroxide decomposition media arranged to receive un-treated aqueous solution; and a water treatment unit comprising an electrochemical cell; wherein the water treatment unit is arranged downstream from the hydrogen peroxide removal unit to receive a pre-treated stream of the aqueous solution with a reduced amount of hydrogen peroxide than the un-treated aqueous solution.

In some embodiments, the electrochemical cell comprises at least one carbonaceous electrode and at least one metal-containing electrode.

In other embodiments, the at least one carbonaceous electrode is a carbon felt, a woven carbon cloth, a carbon film, or a non-woven carbon.

In one or more embodiments, the at least one metal-containing electrode comprises a metal with one or more metal oxides arranged on the metal.

Yet in other embodiments, the hydrogen peroxide removal unit further comprises a container with a fluid inlet, a fluid outlet, and a gas outlet.

In embodiments, the hydrogen peroxide decomposition media comprises a platinum group catalyst.

In one or more embodiments, the hydrogen peroxide decomposition media comprises beads with a density of about 1 to about 10 g/ml.

Yet in other embodiments, the hydrogen peroxide decomposition media comprises a ruthenium catalyst.

Still in other embodiments, wherein the hydrogen peroxide decomposition media does not include a hydrogen peroxide decomposition enzyme, a carbon, or a combination thereof.

In one or more embodiments, the hydrogen peroxide decomposition enzyme is catalase. In some embodiments, the carbon is activated carbon.

In other embodiments, the un-treated aqueous solution has a pH of about 0 to about 14.

According to one or more embodiments, a method for purifying an aqueous stream containing at least one metal impurity comprises flowing an aqueous stream through a hydrogen peroxide removal unit comprising a hydrogen peroxide decomposition media to produce a pre-treated stream with a reduced amount of hydrogen peroxide; and flowing the pre-treated stream through an electrochemical cell arranged downstream from the hydrogen peroxide removal unit to produce a purified stream with a reduced amount of the at least one metal impurity.

In some embodiments, the method further comprises selecting the hydrogen peroxide decomposition media based on a pH of the aqueous stream.

In embodiments, a first hydrogen peroxide decomposition media is selected when the pH of the aqueous stream is a first pH range of about 0 to about 7, and a second hydrogen peroxide decomposition media when the pH of the aqueous stream is a second pH range of about 7 to about 13.

In some embodiments, the first hydrogen peroxide decomposition media comprises a platinum group catalyst.

In other embodiments, the second hydrogen peroxide decomposition media comprises manganese dioxide.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

For a more complete understanding of this disclosure, reference is now made to the following brief description, taken in connection with the accompanying drawings and detailed description, wherein like reference numerals represent like parts:

FIG. 1 is a schematic of the hydrogen peroxide removal unit according to some embodiments.

FIG. 2A is a flowchart of a system for removing hydrogen peroxide from a feed stream for water purification according to some embodiments.

FIG. 2B is a flowchart of a system for removing hydrogen peroxide from a feed stream for water purification according to some embodiments.

FIG. 3 is a flowchart of a system for removing hydrogen peroxide from a feed stream as a pre-treatment step for water purification according to some embodiments.

FIG. 4A is a graph of hydrogen peroxide reduction using a hydrogen peroxide removal unit to treat a feed stream at pH 2 at a flow rate of 250 mL/min according to embodiments.

FIG. 4B is a graph of hydrogen peroxide reduction using a hydrogen peroxide removal unit to treat a feed stream at pH 2 at a flow rate of 500 mL/min according to embodiments.

FIG. 4C is a graph of hydrogen peroxide reduction using a hydrogen peroxide removal unit to treat a feed stream at pH 2 at a flow rate of 1,000 mL/min according to embodiments.

FIG. 5 is a graph of hydrogen peroxide reduction using a hydrogen peroxide removal unit to treat a feed stream at pH 10.5 according to some embodiments.

FIG. 6 is a graph of a hydrogen peroxide reduction using a hydrogen peroxide removal unit to treat a feed stream piranha acid according to some embodiments.

### DETAILED DESCRIPTION

Hydrogen peroxide is crucial in microelectronics manufacturing, serving as a powerful oxidizing agent for cleaning, etching, and surface treatment processes. Piranha solutions, including acid piranha solutions, e.g., a 3:1 to 7:1 mixture of sulfuric acid to hydrogen peroxide, and base piranha solutions, e.g., a 5:1:1 mixture of water to ammonia to hydrogen peroxide, and a mixture of ammonium hydroxide and hydrogen peroxide, are standard chemistries in microelectronics to remove photoresist and organic material residue from silicon wafers, as the strong oxidizing agent will decompose organic matter.

The resulting wastewater, or piranha waste, poses significant risks to downstream reuse membranes, primary and secondary waste treatment equipment, and the environment, if discharged. In some countries, new regulations have been established for transportation of waste peroxides restricting the concentration to less than or equal to 2%, making onsite abatement necessary to maintain operations. No viable solutions exist for effective abatement of acid piranha solutions.

Additionally, removing hydrogen peroxide before further water purification can make the subsequent treatment more effective. For example, reducing hydrogen peroxide in a feed stream before metal(s) removal with an electrochemical cell increases current efficiency and prevents stripping of previously deposited metal(s). In some examples, such processes can be used to remove copper from chemical-mechanical-planarization (CMP) wastewater using an electrochemical cell.

Copper is a critical component for electrification in many industries and applications, e.g., the semiconductor industry, solar panels, and electric vehicles. More than 2,000,000 pounds (lbs) of copper waste is generated every year in the US in semiconductor fabrication processes.

Conventional wastewater treatment methods include ion exchange and the addition of chemicals, which generates hazardous waste that is required to be trucked off-site. The challenges associated with conventional wastewater treatment methods include hazardous waste generation, greenhouse gas emissions, and supply chain risks.

Chemistry processing and trucking are outdated solutions. For example, chemical coagulation results in poor performance with chelators, interferences with hydrogen peroxide, and is highly susceptible to upstream changes. Further, ion exchange, the current state of the art, requires a labor-intensive process that includes pH adjustment, a series of stages using catalytic granulated activated carbon (GAC) to decompose hydrogen peroxide, followed by filtration using a copper selective ion exchange resin. CMP wastewater typically contains, for example, 50 to 1,000 parts-per-million (ppm) hydrogen peroxide. Most ion exchange resin is not tolerant to peroxide, and copper selective resins have low capacity.

While there are upsides to such processes, such as excellent copper removal capability and familiar unit operation, the downsides generally outweigh the upsides. In particular, pre-treatment is often required to prevent resin fouling and degradation, the regeneration system is expensive, and there is lower system flexibility for subsequent upstream process changes.

Other options for peroxide removal include utilizing catalytic carbon or catalase. However, catalase is expensive, temperature sensitive, and bio-growth is problematic.

Accordingly, described herein are methods, systems, and devices that address the foregoing challenges and provide notable advantages. In some embodiments, systems, methods, and devices include a pre-treatment step of reducing hydrogen peroxide with hydrogen peroxide decomposition media that has a longer lifetime than catalase, rapidly decomposes hydrogen peroxide, has a small footprint, operates with a modest temperature increase (e.g., in some embodiments, about 10° C. per wt % of hydrogen peroxide), and has no safety concerns.

In some embodiments, systems, methods, and devices described herein include hydrogen peroxide decomposition media that does not include, or is substantially free of, a hydrogen peroxide decomposition enzyme, a carbon, or a combination thereof. “Substantially free” of a hydrogen peroxide decomposition enzyme, a carbon, or a combination thereof, as used herein, means less than 1 wt. %, less than 0.5 wt. %, less than 0.1 wt. %, or 0 wt. %, based on total weight of the composition. In one or more embodiments, the hydrogen peroxide decomposition media is substantially free of the enzyme catalase.

Also described herein are methods, systems, and devices that treat aqueous solutions downstream from a piranha treatment, or a piranha waste solution. In some embodiments, the piranha waste solution includes piranha solution, diluted piranha solution, neutralized piranha solution, or a combination thereof.

The post-treatment piranha waste solution can include piranha solution, as originally present before use, and/or it can be diluted/partially diluted or neutralized/partially neutralized before treated as described herein.

In some embodiments, the piranha solution in the piranha waste solution resembles the pre-treatment piranha solution and includes sulfuric acid and hydrogen peroxide in a ratio of about 3:1 to about 7:1. In one or more embodiments, the piranha solution in the piranha waste solution includes sulfuric acid and hydrogen peroxide in a ratio of about 3:1, 4:1, 5:1, 6:1, 7:1, or in any range therein.

In other embodiments, piranha solution in the piranha waste solution further includes peroxymonosulfuric acid (H₂SO₅), also called Caro's acid. Yet, in other embodiments, the piranha solution in the piranha waste solution further includes about 0.01% to about 5% peroxymonosulfuric acid (H₂SO₅). Still yet, in other embodiments, the piranha waste solution includes sulfuric acid, hydrogen peroxide, peroxymonosulfuric acid, and water. Yet, in some embodiments, the piranha waste solution includes sulfuric acid, hydrogen peroxide, hydronium ions, bisulfate ions, and atomic oxygen radicals.

In other embodiments, the piranha solution in the piranha waste solution resembles the pre-treatment piranha solution and includes ammonia, hydrogen peroxide, ammonium hydroxide, water, or a combination thereof. In some embodiments, the piranha solution in the piranha waste solution includes water, ammonia, and hydrogen peroxide in a ratio of about a 5:1:1.

In one or more embodiments, the piranha solution in the piranha waste solution includes ammonium hydroxide, sodium hydroxide, or a combination thereof.

In some embodiments, the piranha solution in the piranha waste solution includes diluted piranha solution. In some embodiments, the diluted piranha solution includes about 99% to about 1% weight % (wt. %) water. In other embodiments, the diluted piranha solution includes about or any range between about 99%, 85%, 90%, 85%, 80%, 75%, 70%, 65%, 60%, 55%, 50%, 45%, 40%, 35%, 30%, 35%, 30%, 25%, 20%, 15%, 10%, 5%, and 1% wt. % water.

In some embodiments, the piranha solution in the piranha waste solution includes neutralized piranha solution, which includes a neutralizer, has a pH of about 4 to about 10, or a combination thereof. In embodiments, the neutralizer is sodium bicarbonate, sodium hydroxide, potassium hydroxide, potassium bicarbonate, or a combination thereof. In one or more embodiments, the neutralized piranha solution has a pH about or in any range between about 4, 5, 6, 7, 8, 9, and 10.

In one or more embodiments, the piranha waste solution includes an organic compound, a photoresist, or a combination thereof, resulting from cleaning the wafer or etching the photoresist.

In some embodiments, the hydrogen peroxide decomposition media includes a core-shell structure comprising a catalyst shell deposited on a high surface area substrate core. The catalyst shell of the hydrogen peroxide decomposition media has a redox potential between about 0.7 and about 1.68 Volts (V) vs. a normal hydrogen electrode (NHE), which means that it can both reduce peroxide into water and oxidize it into oxygen. In some embodiments, the catalyst shell of the hydrogen peroxide decomposition media has a redox potential of about or in any range between about 0.8, 0.9, 1.0, 1.1, 1.2, 1.3, 1.4, 1.5, 1.6, and 1.68 V. vs. NHE.

Both the oxidized and reduced forms of the catalyst are stable under most acidic and basic conditions. These advantageous properties enable continuous system operation without the need for a secondary regeneration step. Additionally, the decomposition of hydrogen peroxide is a downhill process and does not require external input of energy to drive the reaction. Unlike Fenton's catalysts, it is not dissolved in solution which prevents stream contamination.

In some embodiments, the hydrogen peroxide decomposition media is in a form of a plurality of beads or spheres and includes a catalyst surface or shell surrounding a core. The core may or may not be catalytic. In some embodiments, the core is catalytic. In other embodiments, the core is non-catalytic. In embodiments, the hydrogen decomposition media includes a platinum group metal catalyst surrounding a core. In other embodiments, hydrogen peroxide decomposition media includes a platinum group metal catalyst surrounding a titanium core. Platinum group metal catalysts include platinum, palladium, rhodium, iridium, osmium, and ruthenium. Non-limiting examples for the core include plastic, tantalum, carbon, ceria/cerium, silica, or any combination thereof. Non-limiting examples for the surrounding catalyst include platinum, ruthenium, rhodium, palladium, osmium, iridium, lead, iridium, silver, gold, manganese, palladium, ceria/cerium, or any combination thereof. In some embodiments, the hydrogen peroxide decomposition media comprises a platinum group catalyst. In other embodiments, the hydrogen peroxide decomposition media comprises a ruthenium catalyst. In other embodiments, the hydrogen peroxide decomposition media comprises a manganese dioxide.

In one or more embodiments, the hydrogen peroxide decomposition media consists of a plurality of spheres of a catalyst surrounding a core. In some embodiments, the hydrogen peroxide decomposition media consists essentially of a plurality of spheres of a catalyst surrounding a core. In other embodiments, the hydrogen peroxide decomposition media comprises a plurality of spheres of a catalyst surrounding a core.

In some embodiments, an intermediate adhesion layer is deposited or arranged between the substrate core and the catalyst shell. Non-limiting examples for the adhesion layer include chrome, titanium, tantalum, tungsten, or a combination thereof.

In one or more embodiments, the hydrogen peroxide decomposition media consists of a plurality of spheres of a catalyst surrounding a core, with an intermediate adhesion layer arranged therebetween. In some embodiments, the hydrogen peroxide decomposition media consists essentially of a plurality of spheres of a catalyst surrounding a core, with an intermediate adhesion layer arranged therebetween. In other embodiments, the hydrogen peroxide decomposition media comprises a plurality of spheres of a catalyst surrounding a core, with an intermediate adhesion layer arranged therebetween.

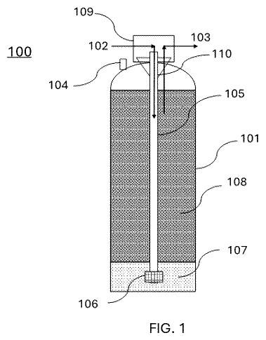

FIG. 1 illustrates the hydrogen peroxide removal unit 100 according to some embodiments. The hydrogen peroxide removal unit 100 includes a bed of gravel 107 and hydrogen peroxide decomposition media 108 arranged thereon that catalyzes the spontaneous decomposition of hydrogen peroxide. In some embodiments, gravel 107 is optional and not included. In other embodiments, a perforated plate can be used instead of gravel 107.

In some embodiments, this process is used to pre-treat an aqueous feed stream (also referred to as an un-treated aqueous solution), wastewater, to be further treated for impurity removal. Both the reduction and oxidation of hydrogen peroxide occur on the decomposition media's surface allowing for prolonged use without the need to regenerate the material to its original state. The media is not consumed by the reduction or oxidation reactions.

In some embodiments, the hydrogen peroxide removal unit 100 includes a tank 101, or container, with a feed stream inlet 102 (also referred to as a fluid inlet) and outlet 103 (also referred to as a fluid outlet) contained within tank head 109, with an optional air release valve 104 (also referred to as a gas outlet) to allow for any gas produced to escape. The feed stream inlet 102 and outlet 103 are shown in FIG. 1 at the top of tank 101 for an up-flow operation; however, the feed stream inlet 102 and outlet 103 are not limited to this configuration. For example, the feed stream inlet 102 and outlet 103 may be at the bottom of tank 101 for a downflow configuration.

In some embodiments, the feed stream is pumped into the unit through a feed stream tube 105 with a feed pump (not shown). The flow rate may be controlled via a variable frequency drive (VFD) or a control valve, not shown. The feed stream then flows down the feed stream tube 105 to the bottom of the tank 101.

In one or more embodiments, the feed stream tube 105 is polyvinyl chloride (PVC). Non-limiting examples of materials for the feed stream tube 105 include polyethylene (PE), polypropylene (PP), chlorinated polyvinyl chloride (CPVC), polyvinylidene fluoride (PVDF), stainless steel, or a combination thereof.

In some embodiments, there is a screen 106, or mesh basket, at the exit of the feed stream tube 105. The screen 106 prevents the likelihood of hydrogen peroxide decomposition media and/or gravel 107 from entering the feed stream tube 105 when operating in a downflow configuration. Additionally, screen 106 breaks up flow in or out of the feed stream tube 105 to reduce channeling. Screen 106 can be a polymer, metal mesh, ceramic, or a combination thereof.

Once tank 101 fills up, the treated stream exits the feed stream outlet 103 at the top of tank 101 as a pre-treated stream. The feed stream outlet 103 has a basket screen 110, or distributor basket, to prevent gravel 107 and/or hydrogen peroxide decomposition media 108 from exiting tank 101 and entering the pre-treated stream.

In some embodiments, tank 101 is first filled with a base of gravel 107, followed by the desired hydrogen peroxide decomposition media 108. Gravel 107 is added to provide an even pressure distribution at the bottom of tank 101 to prevent the feed stream from channeling within the media. Gravel 107 includes a loose aggregation of rock fragments or pounded stones that can be mixed with sand.

In some embodiments, granular gravel with a particle size of 1 to 4 millimeters (mm) is used. In other embodiments, pebble gravel with a particle size of about 4 to about 64 mm is used. The particle size is chosen to be of sufficient coarseness and size as to not significantly impede fluid flow and generate a pressure differential across the gravel bed.

Non-limiting examples of alternative materials to gravel include pellets or chips of plastic, high density polyethylene (HDPE), polytetrafluoroethylene (PTFE), a corrosion resistant ceramic material such as aluminum, or any combination thereof.

In one or more embodiments, tank 101 is polyethylene. Non-limiting examples of materials for tank 101 include fiberglass, poly glass, polyvinyl chloride, vinyl-ester, fiber-reinforced polymer (FRP), 316 stainless steel, or any robust material that is inert to peroxide or acid. In one or more embodiments, the tank 101 may be lined with high-density polyethylene for longevity.

In some embodiments, tank 101 may be non-pressurized and open to the atmosphere. The tank may have one feed stream inlet 102 and one outlet 103. In some embodiments, the tank may have a plurality of inlets and outlets.

The hydrogen peroxide decomposition media 108 is placed on top of the gravel 107 base and may comprise a metal and/or metal oxide species. The media volume is dependent on the volume of the feed stream to be treated.

In some embodiments, the media may include beads with a platinum group metal catalyst with a density of about 1 to 10 g/ml. In other embodiments, the media may include beads with a platinum group metal catalyst with a density of about or at least 1, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.2, 3.3, 3.5, 3.6, 3.7, 3.8, 3.9, and 4.0 g/ml. In even other embodiments, the media may include beads with a platinum group metal catalyst with a density of about or at least 1.59 or 2.7 g/ml. In some embodiments, the bead diameter is about 0.8 mm±0.5 mm.

In some embodiments, hydrogen peroxide removal unit 100 can be operated in a series of two or more units, which may be the same or different, to meet the desired hydrogen peroxide reduction. For example, the first unit could operate at a high velocity, e.g., 30 s residence time, followed by a second unit operating at a lower velocity, e.g., 1 min. In other embodiments, two or more hydrogen peroxide removal units 100 can be operated in parallel to meet the desired hydrogen peroxide reduction.

In some embodiments, hydrogen peroxide removal unit 100 can be operated in a water treatment system including other water treatment unit operations. For example, it could be used before or after a granular activated carbon (GAC), a resin, or a filter and is not limited to the combinations and examples disclosed herein.

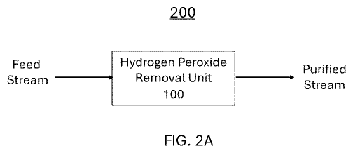

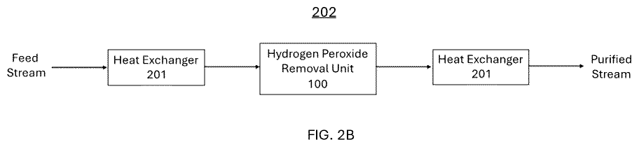

FIGS. 2A and 2B are flowcharts illustrating systems 200, 202 for reducing hydrogen peroxide from a liquid feed stream for stream purification according to some embodiments.

In some embodiments, hydrogen peroxide removal unit 100 can be used to reduce hydrogen peroxide from a liquid feed stream including a mixture of sulfuric acid, hydrogen peroxide, ammonia, ammonium hydroxide, water, or a combination thereof, to produce a purified stream. When an acid piranha solution is treated, the purified stream may include concentrated sulfuric acid.

In some embodiments, as shown in FIG. 2B, a system 202 heats up when in operation due to exothermic reactions. A heat exchanger 201 may optionally be placed upstream from hydrogen peroxide removal unit 100, a heat exchanger 201 may optionally be placed downstream from hydrogen peroxide removal unit 100, or both. This allows for heat to dissipate and cool the feed stream before and/or after treatment and decreases the temperature of the purified stream, improving the lifetime of all components in the system and making the handling of the stream safer. Incorporating heat exchangers into the overall system also decreases the cost of materials. Further, de-bubblers may optionally be placed upstream or downstream from any component in the system to release any gas.

In other embodiments, hydrogen peroxide removal unit 100 can be operated in a series of two or more units to meet the desired hydrogen peroxide reduction. For example, the first unit could operate to remove the majority of the hydrogen peroxide (bulk removal), followed by a second unit to remove the remaining trace amount of hydrogen peroxide (polishing). As an example of this aspect, the bulk removal could reduce a piranha solution including about 75,000 parts-per-million (ppm) hydrogen peroxide to about ≤1 ppm, while the polishing step would further reduce it to about <50 ppb, whereby the purified stream could then be reused.

In other embodiments, two or more hydrogen peroxide removal units 100 can be operated in parallel to meet the desired hydrogen peroxide reduction. Heat exchangers can optionally be placed upstream, downstream, or both, from all hydrogen peroxide removal units in this system. Further, de-bubblers may optionally be placed upstream or downstream from any component in the system to release any gas.

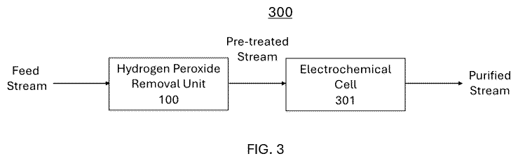

FIG. 3 is a flowchart illustrating system 300 for reducing hydrogen peroxide from a liquid feed stream as a pre-treatment step for stream purification with a water treatment unit according to some embodiments.

In some embodiments, system 300 can be used to first reduce hydrogen peroxide from a liquid feed stream with a hydrogen peroxide removal unit 100 followed by reducing a dissolved metal from the pre-treated liquid stream with electrochemical cell 301 to produce a purified stream. In some embodiments, a storage tank may be placed between the electrochemical cells (not shown).

In one or more embodiments, methods for purifying an aqueous stream containing at least one metal impurity include flowing an aqueous stream through a hydrogen peroxide removal unit comprising a hydrogen peroxide decomposition media to produce a pre-treated stream with a reduced amount of hydrogen peroxide; and flowing the pre-treated stream through an electrochemical cell arranged downstream from the hydrogen peroxide removal unit to produce a purified stream with a reduced amount of the at least one metal impurity.

In some embodiments, the electrochemical cell 301 includes a stack of a plurality of cathodes and anodes, each made of different materials and having different properties. In other embodiments, the electrode stack is formed into a rolled configuration. In one or more embodiments, the electrochemical cell 301 includes a carbon-based electrode (i.e., an anode or cathode), and a metal-based electrode (i.e., an anode or cathode).

In some embodiments, electrochemical cell 301 includes a carbon-based anode and a carbon-based cathode. In some embodiments, electrochemical cell 301 includes a symmetric (i.e., the same carbon-based material for all electrodes) or an asymmetric electrode configuration (i.e., a different carbon-based material for the anode and cathode).

In some embodiments, electrochemical cell 301 includes a membrane (i.e., an anion exchange membrane) arranged on the carbon-based anode. In other embodiments, a membrane (i.e., a cation exchange membrane) is arranged on the carbon-based cathode. The membrane is in a form of a film, a layer, a sheet, a coating, or a combination thereof, and the membrane is arranged on a surface of an electrode (thus, the metal-based anode and/or the carbon-based cathode) or is free-standing. The membrane is on, directly on, or in contact with the electrode in some embodiments. In other embodiments, the membrane surrounds the electrode. In other embodiments, the ion exchange membrane is a bipolar membrane.

In some embodiments, electrochemical cell 301 includes an asymmetric electrode configuration, including a carbon-based (i.e., carbonaceous) cathode, and a non-carbon anode, or in particular, a metal-based (i.e., metal-containing) anode. In other embodiments, the electrochemical cell includes at least one carbonaceous electrode and at least one metal-containing electrode. In some embodiments, the metal-based anode includes a metal substrate with one or more metal oxides (or a metal oxide) coating.

In other embodiments, the electrochemical cell further includes a membrane on the carbon-based cathode and/or on the metal-based anode. The membrane may be a cation exchange membrane or an anion exchange membrane, depending on which electrode the membrane is arranged on. The membrane is in a form of a film, a layer, a sheet, a coating, or a combination thereof, and the membrane is arranged on a surface of an electrode (thus, the metal-based anode and/or the carbon-based cathode) or is free-standing. The membrane is on, directly on, or in contact with the electrode in some embodiments. In other embodiments, the membrane surrounds the electrode. In other embodiments, the ion exchange membrane is a bipolar membrane.

In some embodiments, electrochemical cell 301 includes a carbonaceous cathode surrounding a metal-based anode and a separator arranged between the metal-based anode and the carbonaceous cathode. The electrochemical cell further includes either one of: a conductive cathode current collector housing on the carbonaceous cathode or a non-conductive cathode current collector housing on the carbonaceous cathode. The conductive cathode current collector housing includes at least one inlet and outlet for the liquid stream, and a metal shim arranged between the carbonaceous cathode and the conductive cathode current collector housing. The non-conductive cathode current collector housing includes at least one inlet and outlet for the liquid stream, and a metal shim arranged between the carbonaceous cathode and the non-conductive cathode current collector housing.

In some embodiments, electrochemical cell 301 further includes one or more optional current collectors attached to or in contact with one or both of the carbon-based cathode and the metal-based anode. In other embodiments, one or more optional current collectors are attached to or in contact with one or both of the carbon-based cathode and anode. The current collectors are solid or porous materials. Non-limiting examples of the current collectors are films, layers, metal sheets, foil sheets, or mesh sheets.

Non-limiting examples of materials for the current collectors for the carbon-based cathode include graphite, titanium, stainless steel, or a combination thereof.

Non-limiting examples of materials of current collectors for the metal-based anode include graphite, titanium, stainless steel, aluminum, copper, nickel, or a combination thereof. In some embodiments, the current collector is a planar structure with a thickness of about 0.01 to about 500 millimeters. In some embodiments, the current collector has a thickness of about 0.1 to about 0.4 millimeters.

In one or more embodiments, electrochemical cell 301 further includes a separator arranged between the carbon-based cathode and the metal-based anode. In other embodiments, a separator is arranged between the carbon-based cathode and anode. The separator is a dielectric material and prevents physical and electrical contact between the electrodes.

Non-limiting examples of dielectric materials for the separator include polymeric materials, cellulosic-based materials, silica-based materials, or any combination thereof. In some embodiments, the separator includes polyethylene. In some embodiments, the separator is a planar structure with a thickness of about 1 to about 5000 micrometers. In some embodiments, the separator has a thickness of about 50 to about 250 micrometers.

The carbon-based cathode or the carbon-based anode, is a carbon-based material. Non-limiting examples of the carbon-based material include carbon cloths, carbon films, activated carbon materials, non-woven carbon materials (e.g. carbon felts, carbon aerogels, etc.), or any combination thereof. Carbon cloths are woven carbon cloth, conductive, porous materials that either consist of or consist essentially of carbon. Woven cloths are textiles formed by weaving.

In some embodiments, the woven cloths have a high surface area of about 700 to about 2300 square meters per gram. In other embodiments, the woven cloths have a high surface area of about 1200 to about 2300 square meters per gram. In other embodiments, the woven cloths have a low surface area of about 0.1 to about 5 square meters per gram.

Carbon felts are non-woven porous materials that consist of or consist essentially of carbon. In some embodiments, the carbon felts are activated carbon felts. In other embodiments, the carbon felts are thermally treated or surface oxidized carbon felts. In some embodiments, the carbon felt has a low surface area of less than 5 square meters per gram. In some embodiments, the carbon felt has a high surface area of about 1200 to about 2300 square meters per gram.

Carbon films are carbon composites that consists of or consists essentially of carbon particles and a carbon binder. In one or more embodiments, the carbon film is an activated carbon film that is microporous and includes a binder. Non-limiting examples of the binder of the activated carbon film include polyvinylidene fluoride (PVDF), polytetrafluoroethylene (PTFE), sodium alginate, sodium-carboxymethyl cellulose, an ion exchange polymer, or a combination thereof. In some embodiments, the activated carbon film has a surface area of about 1200 to about 1400 square meters per gram.

In some embodiments, electrochemical cell 301 includes a conical electrochemical cell for metal recovery comprising a metal-based cathode/shim and a metal-based anode. In some embodiments, the metal-based cathode is 316 stainless steel.

The metal-based anode includes a metal substrate with a metal oxide coating. The metal substrate is any coatable metal or metal alloy. The metal substrate can include plates, rods, tubes, wires or knitted wires, and/or expanded meshes of metals or metal alloys. Non-limiting examples of metals for the metal substrate include titanium, tantalum, lead, zirconium, niobium, or any combination or alloy thereof. Non-limiting examples of metal alloys for the metal substrate include titanium nickel alloys, titanium, cobalt alloys, titanium iron alloys, titanium copper alloys, or any combination thereof. According to some embodiments, the metal substrate is a titanium mesh.

In some embodiments, the shim is in a form of a metal sheet, a foil sheet, a mesh sheet, a metal rod, and/or a metal tube. The metal shim is a solid (i.e., non-porous) material in some embodiments. Non-limiting examples of materials for the metal shim include one or more conductive metals, for example, aluminum, copper, graphite, titanium, stainless steel, or a combination thereof.

In one or more embodiments, the metal-based anode includes about 5 grams per square meter (g/m²) of precious metal, but not limited to this amount. For example, the metal-based anode includes less than 2 g/m², or greater than 8 g/m² of precious metal. In some embodiments, the metal-based anode includes about 1 g/m² to about 10 g/m² precious metal, about 2 g/m² to about 8 g/m² precious metal, about 3 g/m² to about 7 g/m² precious metal, or about 4 g/m² to about 6 g/m² precious metal. Non-limiting examples of the precious metal include platinum, gold, or any combination or alloy thereof.

In one or more embodiments, the metal oxide coating on the metal substrate includes ruthenium oxide, iridium oxide, titanium oxide, or a combination thereof. Ruthenium chloride (RuCl₃), iridium chloride (IrCl₃ or H₂IrCl₃), and titanium isopropoxide (Ti{OCH(CH₃)₂}₄), commonly referred to as titanium tetraisopropoxide or TTIP, are combined as precursors in a coating composition, which are deposited on the surface of the metal substrate to form the metal-based anode.

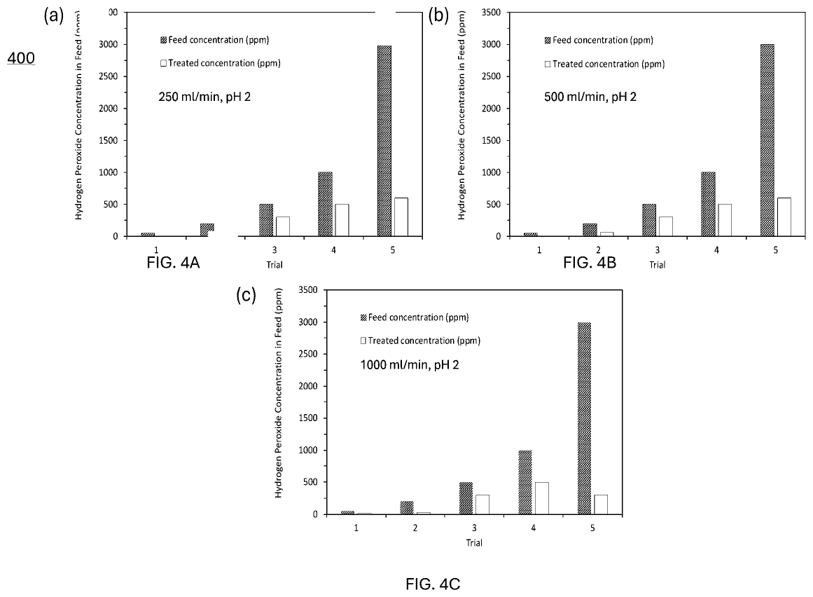

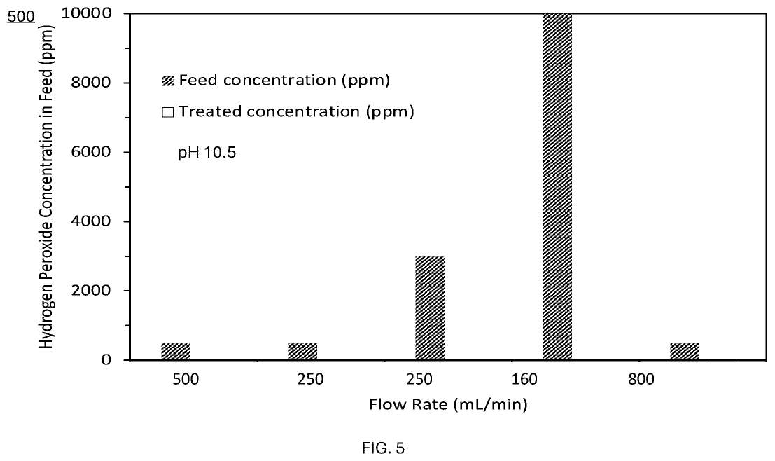

FIGS. 4A, 4B, and 4C illustrate a graph 400 of the performance of a hydrogen peroxide removal unit 100, according to some embodiments. The hydrogen peroxide removal unit 100 can be used to treat a feed stream at pH 2 using a media with a platinum group metal catalyst.

Five trials were conducted at flow rates of (FIG. 4A) 250 ml/min, (FIG. 4B) 500 ml/min, and (FIG. 4C) 1,000 ml/min, for a total feed stream volume of 3,785 mL each. Feed stream concentrations of 50, 200, 500, 1,000, and 3,000 ppm hydrogen peroxide were tested. Hydrogen peroxide reduction decreased with increased feed stream concentration; flow rate, which equates to residence time, had no noticeable effect.

FIG. 5 illustrates a graph 500 of the performance of a hydrogen peroxide removal unit 100, according to some embodiments. The hydrogen peroxide removal unit 100 can be used to treat a feed stream at pH 10.5 using a media with a platinum group metal catalyst.

Five trials were conducted at flow rates of 250 to 800 ml/min, for a total feed stream volume of 3,785 mL each. Hydrogen peroxide reduction was nearly 100% for all combinations of flow rate and feed stream concentration. Test strips to measure the hydrogen peroxide concentration had a detection limit of <0.5 ppm.

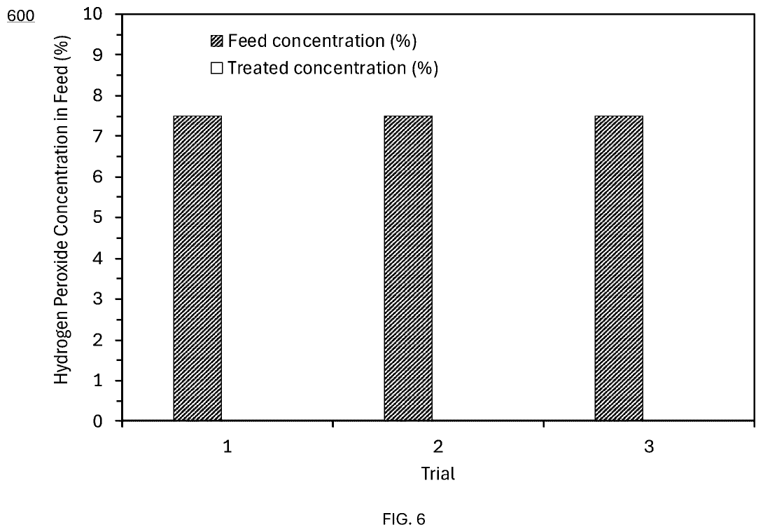

FIG. 6 illustrates a graph 600 of the performance of a hydrogen peroxide removal unit 100, according to some embodiments. The hydrogen peroxide removal unit 100 can be used to treat a feed stream including acid piranha, using a media with a platinum group metal catalyst.

Three trials were conducted at flow rates of 15 to 30 ml/min, for a total feed stream volume of 2 L each. Hydrogen peroxide reduction was 100% for all trials, with the treated concentration measuring 0%. Feed and treated hydrogen peroxide concentrations were measured by iodometric titration. The purified stream was 100% sulfuric acid, being the balance of what remained from the feed stream after hydrogen peroxide was removed.

In some embodiments, different mixture ratios of piranha solutions can be treated. An acid piranha solution including a mixture of up to 3:1 of sulfuric acid to peroxide can be treated. In other embodiments, an acid piranha solution including a mixture of up to 7:1 sulfuric acid to peroxide can be treated. Concentrated sulfuric acid and 30% hydrogen peroxide are commonly used to form these mixtures.

In some embodiments, a base piranha solution including a mixture of 5:1:1 of water to ammonia to hydrogen peroxide can be treated. In other embodiments, a base piranha solution including a mixture of ammonium hydroxide and hydrogen peroxide can be treated.

In other embodiments, the hydrogen peroxide removal unit 100 may operate effectively across a wide range of pH from 0-14 with no need for upstream pH adjustments. The hydrogen peroxide removal unit 100 operates at a pH of about or any range between about 0, 1, 2, 3, 4, 5, 6, 7, 8, 9, 10, 11, 12, 13, and 14.

In some embodiments, the hydrogen peroxide removal unit 100 decomposes hydrogen peroxide at a temperature of about 5 to about 95 degrees Celsius. The temperature is about or in any range between about 5, 10, 15, 20, 25, 30, 35, 40, 45, 50, 55, 60, 65, 70, 75, 80, 85, 90, and 95 degrees Celsius. The ability to operate at lower temperatures than other systems that utilize enzymes is advantageous because it offers a wider operating window.

In some embodiments, methods described herein include selecting the hydrogen peroxide decomposition media based on a pH of the aqueous stream.

In one or more embodiments, a first hydrogen peroxide decomposition media is selected when the pH of the aqueous stream is a first pH range of about 0 to about 7, and a second hydrogen peroxide decomposition media when the pH of the aqueous stream is a second pH range of about 7 to about 13. For example, the first pH range is about or in any range between about 0, 1, 2, 3, 4, 5, 6, and 7. For example, the second pH range is about 7, 8, 9, 10, 11, 12, 13, and 14.

In some embodiments, the first hydrogen peroxide decomposition media comprises a platinum group catalyst. In other embodiments, the second hydrogen peroxide decomposition media comprises manganese dioxide.

In some embodiments, the residence time for hydrogen peroxide reduction from the feed stream is 30-60 seconds.

In some embodiments, the hydrogen peroxide removal unit 100 may accommodate particulate abrasives of small diameter (less than 100 nm).

Each of the compositions, methods, structures, and systems described herein can alternatively comprise, consist of, or consist essentially of, any appropriate materials, steps, or components herein disclosed. The compositions, methods, structures, and systems can additionally, or alternatively, be formulated so as to be devoid, or substantially free, of any materials (or species), steps, or components, that are otherwise not necessary to the achievement of the function or objectives of the compositions, methods, structures, and systems.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. As used herein, the terms “comprising” “including,” “having,” “containing,” “involving,” and the like are to be understood to be open-ended, i.e., to mean “including” but not limited to, unless otherwise noted. “About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or ±5% of the stated value. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Reference throughout the specification to “an aspect”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The flowchart and block diagrams in the Figures illustrate possible implementations of fabrication and/or operation methods according to various embodiments of the present invention. Various functions/operations of the method are represented in the flow diagram by blocks. In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

While the preferred embodiments to the invention have been described, it will be understood that those skilled in the art, both now and in the future, may make various improvements and enhancements which fall within the scope of the claims which follow. These claims should be construed to maintain the proper protection for the invention first described.

What is claimed is:

1. A system for purifying an aqueous solution comprising:
a hydrogen peroxide removal unit comprising a hydrogen peroxide decomposition media arranged to receive un-treated aqueous solution;
wherein the hydrogen peroxide decomposition media comprises a platinum group catalyst comprising beads with a density of at least 1 gram/milliliter (g/ml).

2. The system of claim 1, wherein the beads have a diameter of about 0.8 millimeters (mm).

3. The system of claim 1, wherein the un-treated aqueous solution comprises a mixture of sulfuric acid and hydrogen peroxide.

4. The system of claim 1, further comprising one or more of a heat exchanger, wherein a heat exchanger of the one or more of the heat exchangers is arranged upstream from the hydrogen peroxide removal unit, a heat exchanger of the one or more of the heat exchangers is arranged downstream from the hydrogen peroxide removal unit, or a combination thereof.

5. A system for purifying an aqueous solution comprising:
a hydrogen peroxide removal unit comprising a hydrogen peroxide decomposition media arranged to receive un-treated aqueous solution; and
a water treatment unit comprising an electrochemical cell;
wherein the water treatment unit is arranged downstream from the hydrogen peroxide removal unit to receive a pre-treated stream of the aqueous solution with a reduced amount of hydrogen peroxide than the un-treated aqueous solution.

6. The system of claim 5, wherein the electrochemical cell comprises at least one carbonaceous electrode and at least one metal-containing electrode.

7. The system of claim 6, wherein the at least one carbonaceous electrode is a carbon felt, a woven carbon cloth, a carbon film, or a non-woven carbon.

8. The system of claim 6, wherein the at least one metal-containing electrode comprises a metal with one or more metal oxides arranged on the metal.

9. The system of claim 5, wherein the hydrogen peroxide removal unit further comprises a container with a fluid inlet, a fluid outlet, and a gas outlet.

10. The system of claim 5, wherein the hydrogen peroxide decomposition media comprises a platinum group catalyst.

11. The system of claim 10, wherein the hydrogen peroxide decomposition media comprises beads with a density of about 1 to about 10 g/ml.

12. The system of claim 5, wherein the hydrogen peroxide decomposition media comprises a ruthenium catalyst.

13. The system of claim 5, wherein the hydrogen peroxide decomposition media does not include a hydrogen peroxide decomposition enzyme, a carbon, or a combination thereof.

14. The system of claim 13, wherein the hydrogen peroxide decomposition enzyme is catalase, or the carbon is activated carbon.

15. The system of claim 5, wherein the un-treated aqueous solution has a pH of about 0 to about 14.

16. A method for purifying an aqueous stream containing at least one metal impurity comprising:
flowing an aqueous stream through a hydrogen peroxide removal unit comprising a hydrogen peroxide decomposition media to produce a pre-treated stream with a reduced amount of hydrogen peroxide; and
flowing the pre-treated stream through an electrochemical cell arranged downstream from the hydrogen peroxide removal unit to produce a purified stream with a reduced amount of the at least one metal impurity.

17. The method of claim 16, further comprising selecting the hydrogen peroxide decomposition media based on a pH of the aqueous stream.

18. The method of claim 17, wherein a first hydrogen peroxide decomposition media is selected when the pH of the aqueous stream is a first pH range of about 0 to about 7, and a second hydrogen peroxide decomposition media when the pH of the aqueous stream is a second pH range of about 7 to about 13.

19. The method of claim 18, wherein the first hydrogen peroxide decomposition media comprises a platinum group catalyst.

20. The method of claim 18, wherein the second hydrogen peroxide decomposition media comprises manganese dioxide.
